(19) United States
(12) Patent Application Publication
(10) Pub. No.: US 2015/0156363 A1
(43) Pub. Date: Jun. 4, 2015

(54) IMAGE FORMING APPARATUS AND METHOD FOR CONTROLLING THE SAME, AND STORAGE MEDIUM STORING PROGRAM

(71) Applicant: CANON KABUSHIKI KAISHA, Tokyo (JP)

(72) Inventor: Hiroyoshi Takamiya, Fujisawa-shi (JP)

(21) Appl. No.: 14/537,144

(22) Filed: Nov. 10, 2014

(30) Foreign Application Priority Data
Nov. 29, 2013 (JP) 2013-248339

(51) Int. Cl. H04N 1/00; G06F 1/32

(52) U.S. Cl. CPC H04N 1/00891; G06F 1/3228; G06F 1/3284

(57) ABSTRACT

An image forming apparatus which includes a reading unit and allows an external memory device to be attached the apparatus, displays, on a display unit, a screen for performing a function using the reading unit and the external memory device when the image forming apparatus returns to the active state from the power-saving state depending on a cause for returning, if the cause for returning is that an original document is placed on the reading unit, and the external memory device is attached. The image forming apparatus also displays a default screen on the display unit when the image forming apparatus returns to the active state from the power-saving state, if the cause for returning is that an original document is placed on the reading unit, and the external memory device is not attached.

### BACKGROUND OF THE INVENTION

1. Field of the Invention

The present invention relates to an image forming apparatus having a power-saving mode in which the image forming apparatus is in a power-saving state, and a method for controlling the image forming apparatus, and a storage medium storing a program.

2. Description of the Related Art

Multifunction peripherals, which have multiple functions which allow the apparatus to act as a scanner, a printer, a fax machine, and a copier, have been widely used. In a multifunction peripheral, when the user selects a desired function on the ready screen, a setting screen corresponding to the function is displayed, and the user uses the setting screen to set details of the function which the user desires the apparatus to execute.

A technique of simplifying such an operation performed by the user is described in, for example, Japanese Patent Laid-Open No. 2010-87670. In Japanese Patent Laid-Open No. 2010-87670, when a USB memory device is attached to the apparatus while the ready screen is displayed, it is determined whether or not an original document is placed on a scanner. If an original document is placed, the apparatus transitions to a process of scanning the original document and storing image data to the USB memory device. Also, in Japanese Patent Laid-Open No. 2010-87670, if an original document is not placed on the scanner when a USB memory device is attached to the apparatus, the apparatus transitions to a direct printing process of printing data of the USB memory device.

Incidentally, multifunction peripherals etc. are provided with a power-saving mode in order to reduce power consumption. In the power-saving mode, the apparatus is put into a power-saving state in which power is not supplied to a scanner unit or a printer unit when the apparatus is not operating. In a multifunction peripheral, when the apparatus returns to the active state from the power-saving state, a predetermined operation screen is displayed, and the apparatus receives the user's operation through the operation screen, and performs a function selected by the user.

Therefore, a default screen is displayed whenever the apparatus returns to the active state from the power-saving state, and the user has to select a desired function from the default screen, and set details of the function. Therefore, it is desirable that even when the apparatus returns to the active state from the power-saving state, a screen which allows the user to perform a simple operation should be displayed.

### SUMMARY OF THE INVENTION

An aspect of the present invention is to eliminate the above-mentioned problems with the conventional technology.

The present invention provides a technique of allowing an image forming apparatus to return to the active state from the power-saving state when an original document is placed, and at this time, displaying a screen showing an executable function, depending on whether or not an external memory device is attached to the image forming apparatus, thereby reducing the user's operation.

The present invention in one aspect provides an image forming apparatus comprising: a reading unit configured to read an original document to generate image data of the original document; an attachment unit configured to allow an external memory device to be attached to the image forming apparatus; a detection unit configured to detect that an original document is placed on the reading unit; a return unit configured to cause the image forming apparatus to return to an active state from a power-saving state depending on a cause for returning from the power-saving state; and a control unit configured to display, on a display unit, a screen for performing a function using the reading unit and the external memory device when the return unit causes the image forming apparatus to return to the active state from the power-saving state, in a case where the cause for returning is the detection by the detection unit, and the external memory device is attached to the image forming apparatus, and display a default screen on the display unit when the return unit causes the image forming apparatus to return to the active state from the power-saving state, in a case where the cause for returning is the detection by the detection unit, and the external memory device is not attached to the image forming apparatus.

According to the aspect of the present invention, an image forming apparatus is allowed to return to the active state from the power-saving state when an original document is placed, and at this time, show a screen showing an executable function, depending on whether or not an external memory device is attached to the image forming apparatus, whereby the user's operation which is performed after the image forming apparatus has returned to the active state from the power-saving state can be advantageously reduced.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an image forming apparatus.

FIG. 2 is a top view for describing an operation panel of the image forming apparatus.

FIG. 3 is a diagram for describing power supply in the image forming apparatus.

FIG. 4A is a diagram showing causes which make the image forming apparatus return to the active state from the power-saving state, and information which is used to determine a return screen which is to be displayed on a display unit, depending on the cause.

FIGS. 4B to 4D are diagrams showing example return screens.

FIG. 5A is a flowchart for describing a process which is performed when the image forming apparatus returns to the active state from the power-saving state.

FIG. 5B is a diagram showing an example screen which is used to select a standard function which is set as a default when the image forming apparatus returns to the active state.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. The same parts are indicated by the same reference characters and will not be redundantly described.

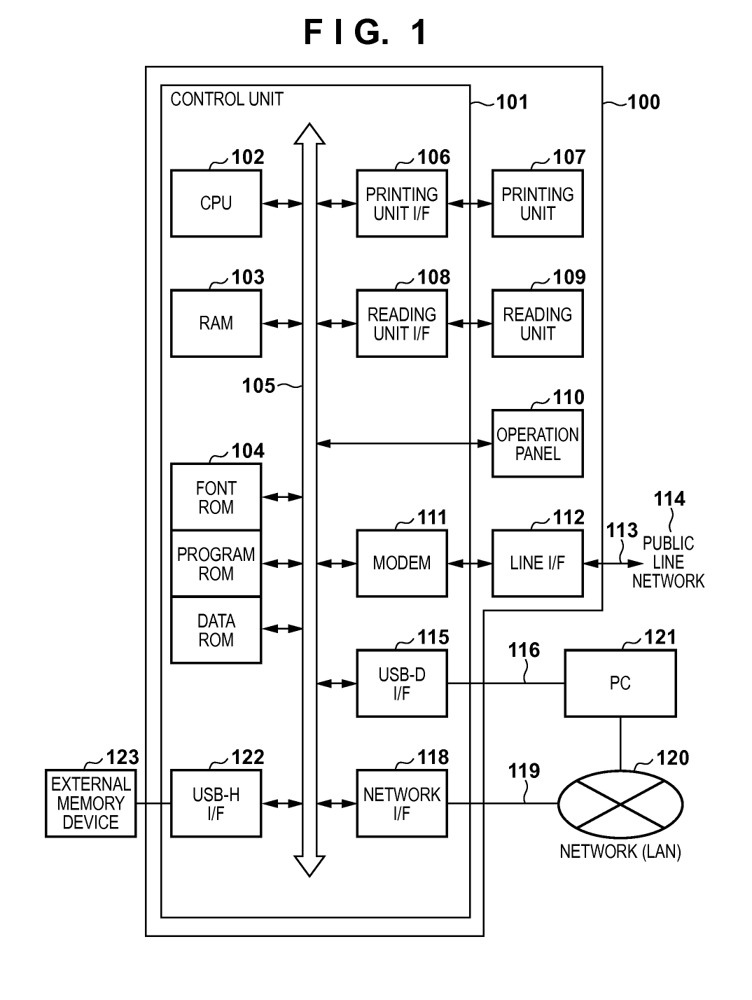

FIG. 1 is a block diagram showing a hardware configuration of an image forming apparatus 100 according to an embodiment of the present invention.

The image forming apparatus 100 includes a printing unit 107, a reading unit 109 which reads an original document to generate image data, an operation panel 110, a line I/F 112, and a control unit 101 which controls these units.

The control unit 101 includes a CPU 102, a RAM 103, a ROM 104, a printing unit I/F 106, a reading unit I/F 108, a modem 111, a USB-D I/F 115, a network I/F 118, and a USB-H I/F 122. These parts are connected to the CPU 102 through a system bus 105. The CPU 102 comprehensively controls the above units in accordance with respective control programs stored in the ROM 104. The control programs are stored in a program area of the ROM 104. When a control program is executed, the compressed data of the control program stored in the program area of the ROM 104 is decompressed and loaded to the RAM 103. The control programs may be stored in a hard disk drive (HDD) (not shown) in a compressed or non-compressed form, and loaded to the RAM 103 in accordance with a boot program stored in the ROM 104.

The network I/F 118 performs a communication process with a host computer 121 (hereinafter referred to as a “PC”) through a network (LAN) 120 etc. The network I/F 118 and the network 120 are connected together through a communication cable, such as a LAN cable 119 etc. The PC 121 can be connected to a USB cable 116 through the USB-D I/F 115. The modem 111 is connected to a public line network 114 through the line I/F 112, and performs a communication process with another image forming apparatus, a fax machine, a telephone, etc., (not shown). The line I/F 112 and the public line network 114 are connected together typically through a telephone line 113 etc. An external memory device 123 is attached to the image forming apparatus 100 through the USB-H I/F 122.

The printing unit I/F 106 is an interface which outputs an image signal to the printing unit 107 (printer engine). The reading unit I/F 108 is an interface which receives an image signal from the reading unit 109 (scanner engine). During a copying operation etc., the CPU 102 processes an image signal received through the reading unit I/F 108, and outputs the resultant signal as an image signal to be recorded to the printing unit I/F 106.

The CPU 102 uses font information stored in a font area of the ROM 104 to display characters or symbols on a display unit of the operation panel 110, or receives instruction information specified by the user using the operation panel 110. A data area of the ROM 104 is used to store apparatus information of the image forming apparatus 100, the user's telephone directory information, department management information, etc. The CPU 102 reads data from the data area and updates the data area when necessary.

Although, in FIG. 1, the reading unit 109 and the printing unit 107 are included in the image forming apparatus 100, either or both of them may be provided external to the image forming apparatus 100.

The image forming apparatus 100 of this embodiment is assumed to have a copying function which is carried out by the reading unit 109 and the printing unit 107, a scanning function which is carried out by the reading unit 109 and the USB-D I/F 115, etc. In addition, the image forming apparatus 100 of this embodiment is assumed to have a faxing function which is carried out by the modem 111, a printing function which is performed in accordance with an instruction received from the PC 121 through the USB cable 116 or the network 120, and a function of printing image data stored in the external memory device 123.

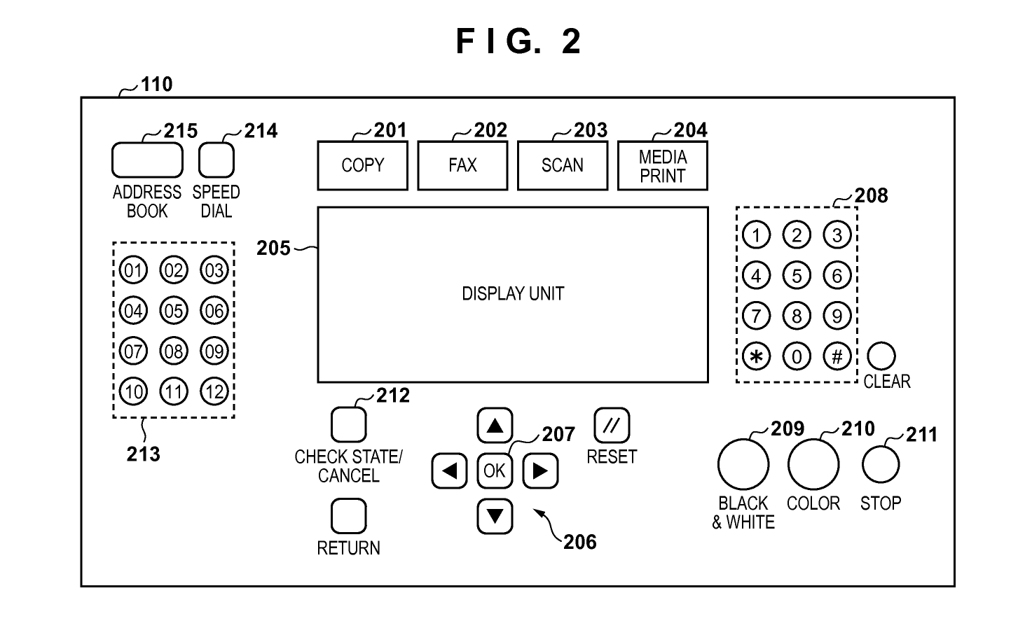

FIG. 2 is a top view for describing the operation panel 110 of the image forming apparatus 100 of the embodiment.

The operation panel 110 has function keys 201 to 204 which are used to select the above functions. The user presses a key corresponding to a function which the user desires to use, to instruct the image forming apparatus 100 to perform the function. The operation panel 110 also has a display unit 205 for notifying the user of settings and conditions of the image forming apparatus 100. Arrow keys 206 are used to move a cursor etc. displayed on the display unit 205. The arrow keys 206 include four buttons indicating upward, downward, leftward, and rightward directions. The arrow keys 206 also include an OK key 207 at the center, which functions as a “confirm key” for settings or inquiries. The user uses a ten-key 208 to input the number of copies, a telephone number in the faxing function, etc.

A black-and-white start key 209 and a color start key 210 are also provided for instructing the image forming apparatus 100 to start copying, scanning, or faxing. Note that if the image forming apparatus has a function of automatically determining whether an original document is a color one or a monochromatic one when the original document is read by the reading unit 109, the color and monochromatic start keys of FIG. 2 may not be provided. A stop key 211 is provided for instructing the image forming apparatus 100 to stop each function. Alternatively, the user may use a state check/cancel key 212 as a means for stopping an operation, select a process which the user desires to stop from a state check screen showing a state of a process which is currently performed by the image forming apparatus 100, and stop the process. Also in this case, selection and confirmation are performed using the arrow keys 206 and the OK key 207.

One-touch keys 213, a speed dial key 214, and an address book key 215 are provided as a means for easily specifying a destination when a facsimile is sent. The one-touch keys 213 are assigned respective destinations. If a desired one-touch key 213 is pressed down, a destination assigned to the key can be selected. When the speed dial key 214 is pressed down, a screen which prompts the user to input a number is displayed, and the user can specify a destination by inputting a number assigned to the desired destination using the ten-key 208. The address book key 215 is used to display a list of destinations registered in the image forming apparatus 100. A desired destination is selected from the displayed destination list using the arrow keys 206, and that destination is decided on as the transmission destination using the OK key 207.

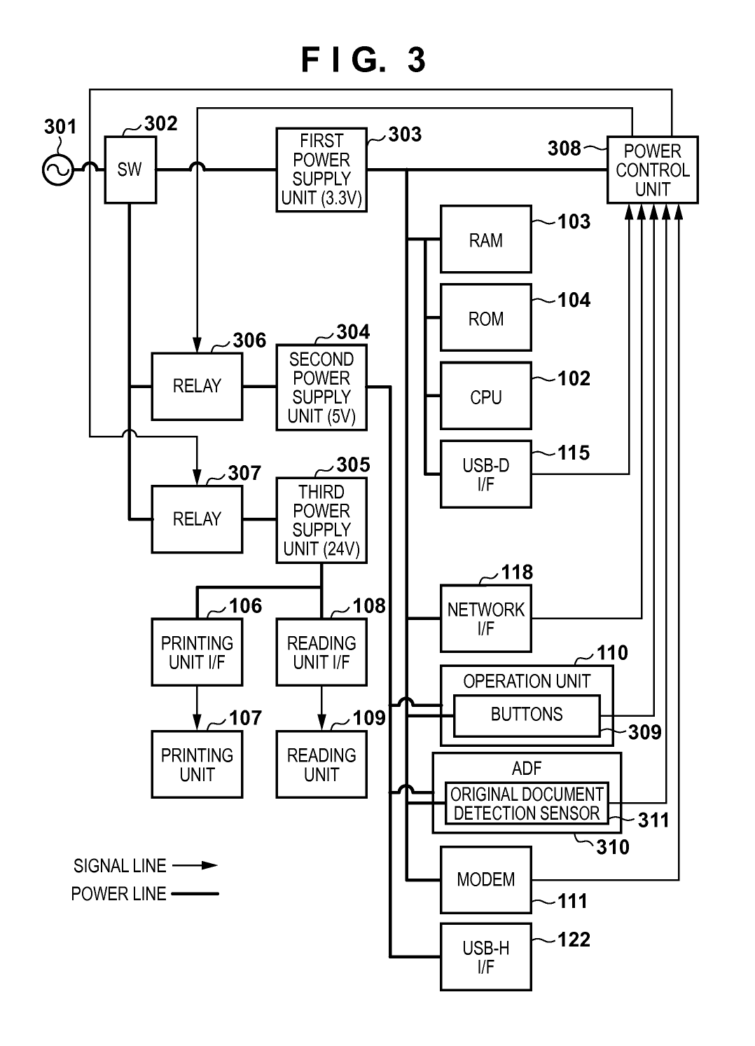

FIG. 3 is a diagram for describing power supply in the image forming apparatus 100 of the embodiment.

Power is supplied by a commercial alternating current power supply 301 through a SW 302. The power supplied by the alternating current power supply 301 is converted into a 3.3-V direct current by a first power supply unit 303. The 3.3-V direct current is used to supply power to the CPU 102, the RAM 103, the ROM 104, the USB-D I/F 115, the network I/F 118, various buttons 309, an original document detection sensor 311, and the modem 111, which always require power. The buttons 309 provided on the operation panel 110 are always supplied with power, and therefore, in the power-saving state, a key operation which is performed by the user through the operation panel 110 can be detected. The original document detection sensor 311, which is included in an automatic document feeder (ADF) 310, is also always supplied with power, and therefore, can detect that an original document is placed on the ADF 310 in the power-saving state. Therefore, these key operations and placement of an original document may cause the image forming apparatus to return to the active state from the power-saving state.

A second power supply unit 304 converts power supplied from the alternating current power supply 301 into a 5-V direct current, which is then supplied to the operation panel 110, the ADF 310, and the USB-H I/F 122. A third power supply unit 305 converts power supplied from the alternating current power supply 301 into a 24-V direct current, which is then supplied to the printing unit I/F 106, the printing unit 107, the reading unit I/F 108, and the reading unit 109. The second power supply unit 304 and the third power supply unit 305 do not supply power in the power-saving state.

A power control unit 308 is notified of job submission from the USB-D I/F 115, the network I/F 118, or the modem 111, and signals from the buttons 309 and the original document detection sensor 311, which cause the image forming apparatus 100 to return to the active state from the power-saving state. The power control unit 308, when receiving any of these signals, turns relays 306 and 307 on so that the alternating current power supply 301 supplies power to the second power supply unit 304 and the third power supply unit 305. As a result, power supply to units connected to the second power supply unit 304 and the third power supply unit 305 is resumed, and the image forming apparatus 100 returns to the active state from the power-saving state. Note that, here, the USB-H I/F 122 is connected to the second power supply unit 304, and therefore, in the power-saving state, attachment of the external memory device 123 to the USB-H I/F 122 cannot be detected.

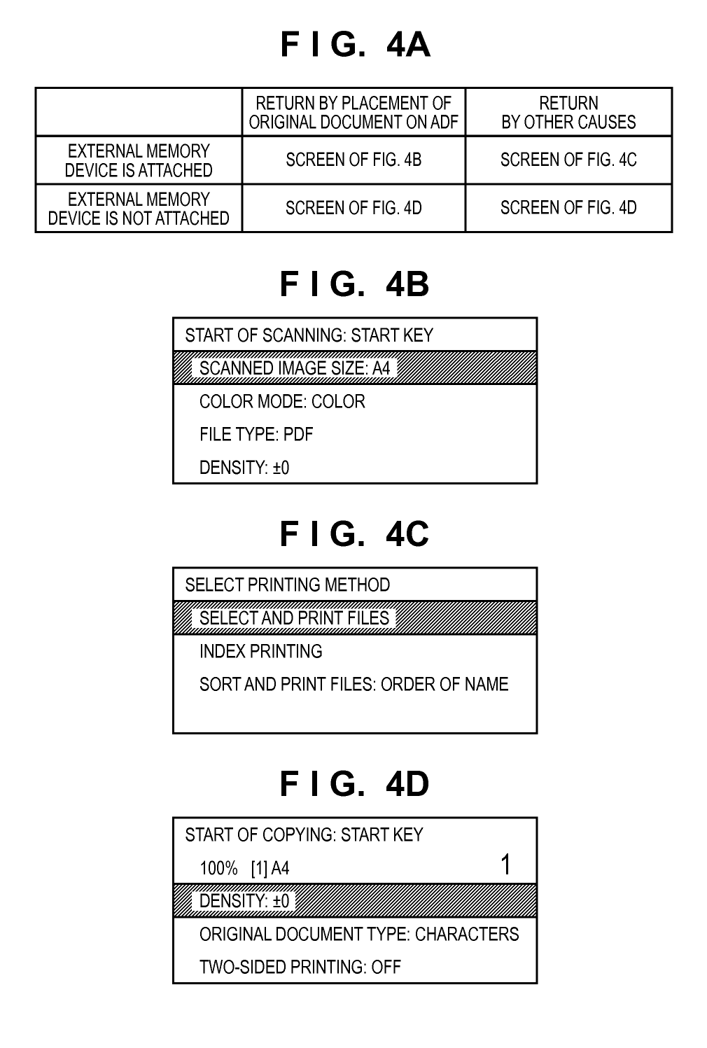

FIG. 4A is a diagram showing causes which make the image forming apparatus 100 of the embodiment return to the active state from the power-saving state, and information which is used to determine a return screen which is to be displayed on the display unit 205, depending on the cause.

Here, the return screen is determined based on whether or not the external memory device 123 is attached and whether or not an original document is placed on the ADF 310, as described below.

FIG. 4B is a diagram showing an example return screen which is displayed when the image forming apparatus 100 returns to the active state from the power-saving state because an original document is placed on the ADF 310 while the external memory device 123 is attached.

In FIG. 4B, a scan start screen is displayed for starting reading of an original document using the reading unit 109. A read size, color mode, file format, etc. for an original document can be set using this screen. Here, assuming that image data obtained by reading an original document using the reading unit 109 is stored to the external memory device 123, a “scan to external memory device” function screen is displayed.

FIG. 4C is a diagram showing an example return screen which is displayed when the image forming apparatus 100 returns to the active state from the power-saving state because other causes than placement of an original document on the ADF 310 occur while the external memory device 123 is attached.

In FIG. 4C, a screen is displayed for selecting and printing a file stored in the external memory device 123. A file, a printing type, etc. can be set using this screen. Here, assuming that image data stored in the external memory device 123 is printed, a “print from external memory device” function screen is displayed.

FIG. 4D is a diagram showing an example return screen which is displayed when the image forming apparatus 100 returns to the active state from the power-saving state because an original document is placed on the ADF 310 while the external memory device 123 is not attached, or because other causes than placement of an original document on the ADF 310 occur while the external memory device 123 is not attached.

In FIG. 4D, a screen is displayed for starting copying in which an original document is read by the reading unit 109 and printed by the printing unit 107. Paper selection, a print density, an original document type, the presence or absence of two-sided printing, etc. can be set using this screen. Here, assuming that a copying function screen is set as a standard return screen set in the image forming apparatus 100, the copying function screen is displayed.

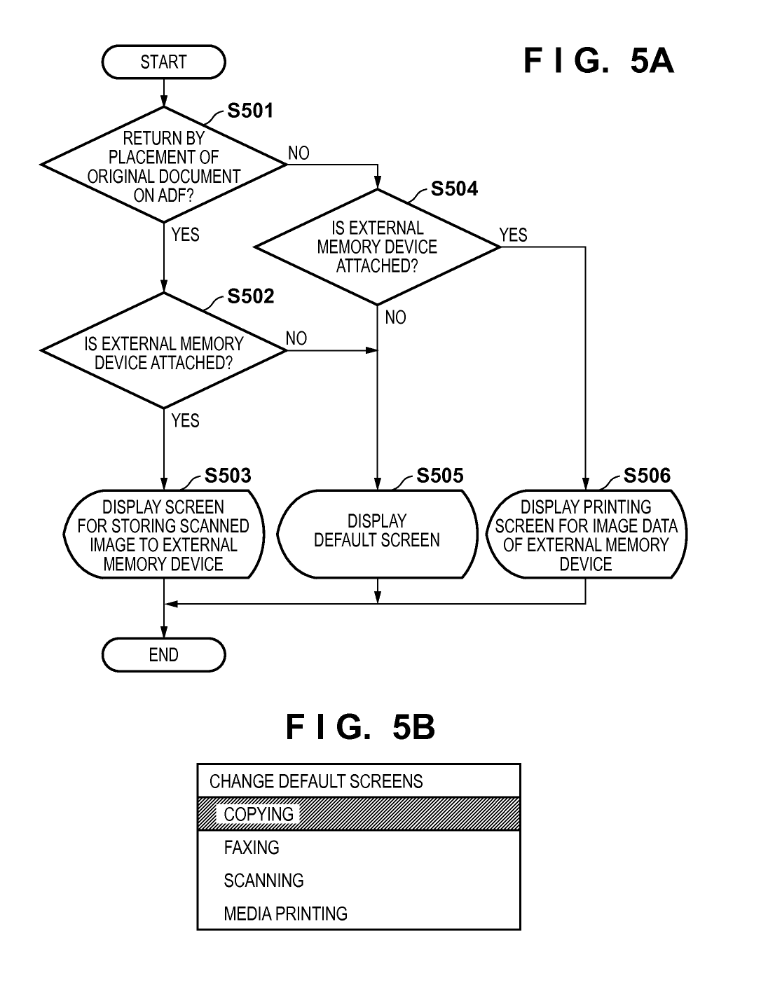

FIG. 5A is a flowchart for describing a process which is performed when the image forming apparatus 100 of this embodiment returns to the active state from the power-saving state. A program for executing this process is stored in, for example, the ROM 104, and is loaded to the RAM 103 for execution, and is executed under the control of the CPU 102.

This process is started when the image forming apparatus 100 returns to the active state from the power-saving state. Initially, in step S501, the CPU 102 determines whether or not the image forming apparatus 100 has returned to the active state from the power-saving state because the original document detection sensor 311 of the ADF 310 detected that an original document is placed on the ADF 310. If the result of the determination in step S501 is positive, control proceeds to step S502, in which the CPU 102 determines whether or not the external memory device 123 is attached. If the result of the determination in step S502 is positive, control proceeds to step S503, in which, for example, the “scan to external memory device” function screen shown in FIG. 4B is displayed, and the process is ended. On the other hand, if the result of the determination in step S502 is negative, control proceeds to step S505, in which the standard return screen (e.g., FIG. 4D) of the image forming apparatus 100 is displayed, and the process is ended.

If, in step S501, the CPU 102 determines that the image forming apparatus 100 has returned to the active state from the power-saving state because of other causes than placement of an original document on the ADF 310, control proceeds to step S504, in which the CPU 102 determines whether or not the external memory device 123 is attached. If the result of the determination in step S504 is positive, control proceeds to step S506, in which, for example, the CPU 102 displays the “print from external memory device” function scree of FIG. 4C, and ends the process. On the other hand, if the result of the determination in step S504 is negative, control proceeds to step S505, in which the standard return screen (e.g., FIG. 4D) of the image forming apparatus 100 is displayed, and the process is ended. Therefore, when the external memory device 123 is not attached, the standard return screen set in the image forming apparatus 100 is displayed irrespective of the return cause.

FIG. 5B is a diagram showing an example screen which is used to select a standard function which is set as a default when the image forming apparatus 100 of the embodiment returns to the active state.

The function which is set using this screen will be used as the function screen of FIG. 4D. In the screen of FIG. 5B, “copying” is selected as a default screen. Therefore, in this case, for example, as shown in FIG. 4D, a screen for starting copying is displayed as a default screen.

As described above, according to this embodiment, a suitable return screen can be displayed, depending on whether or not the image forming apparatus has returned to the active state from the power-saving state because an original document is placed on the reading unit, and whether or not an external memory device is attached when the image forming apparatus has returned to the active state from the power-saving state.

In other words, in this embodiment, a return screen can be displayed which shows a function which can be executed, depending on the state of the image forming apparatus, the connection state of a memory, etc., as they are when the image forming apparatus returns to the active state from the power-saving state. As a result, the user can cause the image forming apparatus to perform their intended function from the return screen without changing the return screen.

In this embodiment, a default screen can be set using the screen of FIG. 5B. Therefore, for example, when the image forming apparatus returns to the active state because an original document is placed on the ADF 310 while the external memory device 123 is not attached, a fax sending screen may be displayed instead of a copy screen.

If the cause for returning is the user's key operation performed on the operation unit, a return screen corresponding to that key operation may be displayed.

Although not shown in FIG. 5B, “selected depending on cause for returning” may be provided as an option for setting a default screen. As a result, for example, when the image forming apparatus returns to the active state in response to a key operation on the operation panel 110, a fax sending screen or a copy screen can be displayed. For example, when the image forming apparatus returns to the active state in response to reception from the network, a printing screen can be displayed. For example, when the image forming apparatus returns to the active state in response to data reception by the modem 111, a fax receiving screen can be displayed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-248339, filed Nov. 29, 2013, which is hereby incorporated by reference herein in its entirety.

What is claimed is:

1. An image forming apparatus comprising:
a reading unit configured to read an original document to generate image data of the original document;
an attachment unit configured to allow an external memory device to be attached to the image forming apparatus;
a detection unit configured to detect that an original document is placed on the reading unit;
a return unit configured to cause the image forming apparatus to return to an active state from a power-saving state depending on a cause for returning from the power-saving state; and
a control unit configured to display, on a display unit, a screen for performing a function using the reading unit and the external memory device when the return unit causes the image forming apparatus to return to the active state from the power-saving state, in a case where the cause for returning is the detection by the detection unit, and the external memory device is attached to the image forming apparatus, and
display a default screen on the display unit when the return unit causes the image forming apparatus to return to the active state from the power-saving state, in a case where the cause for returning is the detection by the detection unit, and the external memory device is not attached to the image forming apparatus.

2. The image forming apparatus according to claim 1, wherein
the control unit is further configured to display, on the display unit, a screen for performing a function using the external memory device when the return unit causes the image forming apparatus to return to the active state from the power-saving state, in a case where the cause for returning is not the detection by the detection unit, and the external memory device is attached to the image forming apparatus.

3. The image forming apparatus according to claim 1, wherein
the control unit is further configured to display the default screen on the display unit when the return unit causes the image forming apparatus to return to the active state from the power-saving state, irrespective of the cause for returning, in a case where the external memory device is not attached to the image forming apparatus.

4. The image forming apparatus according to claim 1, wherein
the cause for returning includes a key operation performed by a user on an operation unit, and when the return unit causes the image forming apparatus to return to the active state from the power-saving state, the control unit displays a return screen corresponding to the key operation on the operation unit which is the cause for returning.

5. The image forming apparatus according to claim 1, further comprising:
a setting unit configured to set the default screen,
wherein
the control unit displays the default screen set by the setting unit.

6. A method for controlling an image forming apparatus including a reading unit configured to read an original document to generate image data of the original document, and an attachment unit configured to allow an external memory device to be attached to the image forming apparatus, the method comprising:
a detection step of detecting that an original document is placed on the reading unit;
a return step of causing the image forming apparatus to return to an active state from a power-saving state depending on a cause for returning from the power-saving state; and
a control step of displaying, on a display unit, a screen for performing a function using the reading unit and the external memory device when the return unit causes the image forming apparatus to return to the active state from the power-saving state, in a case where the cause for returning is the detection by the detection step, and the external memory device is attached to the image forming apparatus, and displaying a default screen on the display unit when the return unit causes the image forming apparatus to return to the active state from the power-saving state, in a case where the cause for returning is the detection by the detection step, and the external memory device is not attached to the image forming apparatus.

7. A non-transitory computer-readable storage medium storing a program for causing a computer to execute each of the steps of the method according to claim 6.
